(19) United States
(12) Patent Application Publication
(10) Pub. No.: US 2025/0118301 A1
(43) Pub. Date: Apr. 10, 2025

(54) APPARATUS AND METHOD FOR SPEECH RECOGNITION IN VEHICLE HEAD UNIT SYSTEM

(71) Applicants: HYUNDAI MOTOR COMPANY, Seoul (KR); KIA CORPORATION, Seoul (KR)

(72) Inventor: Jang Sun LEE, Seoul (KR)

(21) Appl. No.: 18/611,386

(22) Filed: Mar. 20, 2024

(30) Foreign Application Priority Data
Oct. 4, 2023 (KR) 10-2023-0131718

(51) Int. Cl. G10L 15/22; G10L 15/20

(52) U.S. Cl. CPC G10L 15/22; G10L 15/20; G10L 2015/223

(57) ABSTRACT

A method for speech recognition in a vehicle includes processing an utterance of a first passenger, the utterance requesting execution of speech recognition, generating a command list based on the utterance, determining, based on a plurality of utterances being simultaneously received from a plurality of seats, respectively, intention of each of the plurality of utterances, and processing a speech act of a first utterance among the plurality of utterances based on the intention of each utterance.

### CROSS-REFERENCE TO RELATED APPLICATION

The present application claims priority to Korean Patent Application No. 10-2023-0131718, filed on in Korea Intellectual Property Office on Oct. 4, 2023, the entire contents of which are incorporated herein by reference.

### TECHNICAL FIELD

The present disclosure relates to an apparatus and a method for speech recognition in a vehicle head unit system.

### BACKGROUND

Speech recognition refers to the process of extracting phonemes, i.e., linguistic information, from acoustic information contained in speech and making a machine recognize and respond to the extracted phonemes.

When speech recognition is performed at a specific seat in a vehicle, a microphone only at the speaker's seat location is activated to better recognize the voice of the speaker who performs the speech recognition. Therefore, voices of passengers in other seats are not recognized properly. If microphones at all seat locations are activated to recognize voices from passengers in other seats to address this problem, unexpected actions may occur as unintentional speech unrelated to the speech recognition task intended by the speaker performing speech recognition may be introduced.

### SUMMARY

One object of the present disclosure is to provide an apparatus and a method for speech recognition by extracting voices determined as valid commands among the voices of passengers in other seats in a vehicle head unit system.

One object of the present disclosure is to provide an apparatus and a method for naturally interacting with a speech recognition system even in an environment where several people speak freely at the same time in a vehicle head unit system.

Technical objects to be achieved by the present disclosure are not limited to those described above, and other technical objects not mentioned above may also be clearly understood from the descriptions given below by those skilled in the art to which the present disclosure belongs.

According to an aspect of the present disclosure, a method for speech recognition in a vehicle can include: processing an utterance of a first passenger, the utterance requesting execution of speech recognition, generating a command list based on the utterance, determining, based on a plurality of utterances being simultaneously received from a plurality of seats, respectively, intention of each of the plurality of utterances, and processing a speech act of a first utterance among the plurality of utterances based on the intention of each utterance.

According to another aspect of the present disclosure, an apparatus for speech recognition in a vehicle can include: a memory storing instructions; and a processor configured to execute the instructions to perform operations comprising: processing an utterance of a first passenger, the utterance requesting execution of speech recognition, generating a commands list based on the utterance, determining, based on a plurality of utterances being simultaneously received from a plurality of seats, respectively, intention of each of the plurality of utterances; and processing a speech act of a first utterance among the plurality of utterances based on the intention of from each utterance.

The present disclosure may extract and recognize voices deemed to be valid commands from among the voices of passengers in other seats in a vehicle head unit system.

The present disclosure may enable natural interaction with a speech recognition system even in an environment where several people speak freely at the same time in a vehicle head unit system.

The present disclosure prevents a speech recognition system from malfunctioning due to recognition of unnecessary voices even in a vehicle environment where not only the speaker who has executed speech recognition but also other passengers speak freely at the same time and enables natural interaction with the speech recognition system, thereby providing enhanced passenger experiences.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a first flow diagram illustrating a speech recognition method.

FIG. 2 is a second flow diagram illustrating a speech recognition method.

FIG. 3 is a flow diagram illustrating a speech recognition method.

FIG. 4 is a block diagram of a speech recognition apparatus.

FIG. 5 is a first example illustrating a speech recognition method used in the right rear seat in a vehicle.

FIG. 6 is a second example illustrating a speech recognition method used in the right rear seat in a vehicle.

FIG. 7 is a third example illustrating a speech recognition method used in the right rear seat in a vehicle.

### DETAILED DESCRIPTION

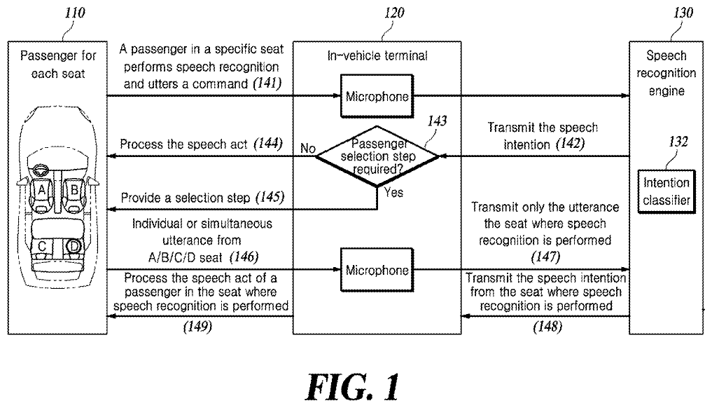

FIG. 1 is a first flow diagram illustrating a speech recognition method.

A passenger 110 for each seat (e.g., a passenger in the D position of the vehicle) may utter a command after executing speech recognition in the step 141. The command may be, for example, “Open the window” or “Let's go to xx cafe.” The uttered voice may be transmitted to a speech recognition engine 130 through a microphone of an in-vehicle terminal 120.

The speech recognition engine 130 transmits the speech intention to the in-vehicle terminal 120 after speech recognition in the step 142. The speech intention may be, for example, “open the window” or “guide to xx cafe.”

In the step 143, the in-vehicle terminal 120 may determine whether a passenger selection step is required.

If the passenger selection step is not required, the in-vehicle terminal 120 processes a guide message such as “I will open the window” or an operation such as “opening the window” for the passenger 110 of each seat in the step 144.

On the other hand, if the passenger selection step is required, the in-vehicle terminal 120 may provide a selection step to the passenger 110 of each seat in the step 145. The selection step may include, for example, provision of selection items and guidance, such as “Where should I take you?” For example, the selection items are shown in Table 1 below.

TABLE 1

| | | | | |
|---|---|---|---|---|
| 1 | 301 | m | POI Name | POI detail Address |
| 2 | 500 | m | POI Name | POI detail Address |
| 3 | 1 | km | POI Name | POI detail Address |
| 4 | 1.1 | km | POI Name | POI detail Address |

| | | | |
|---|---|---|---|
| 5 | . . . | . . . | . . . |

It may be possible to list up operable commands before the selection items are provided in the step 145. The passengers 110 for each seat may speak individually or simultaneously in the A/B/C/D seat in the step 146. The uttered voice may be transmitted to the speech recognition engine 130 through the microphone of the in-vehicle terminal 120 in the step 147. At this time, since the method activates only the microphone corresponding to the seat where speech recognition is performed, only utterances from the specific seat (e.g. the seat where speech recognition is performed) may be transmitted to the speech recognition engine 130. The content spoken from other seats may not be transmitted to the speech recognition engine 130.

The speech recognition engine 130 may transmit the speech intention from the seat where speech recognition is performed to the in-vehicle terminal 120 in the step 148.

In the step 149, the in-vehicle terminal 120 may process the speech act of a passenger in the seat where speech recognition is performed. In the procedure of FIG. 1, voice interaction is not allowed for those seats other than the seat at the D position of the vehicle.

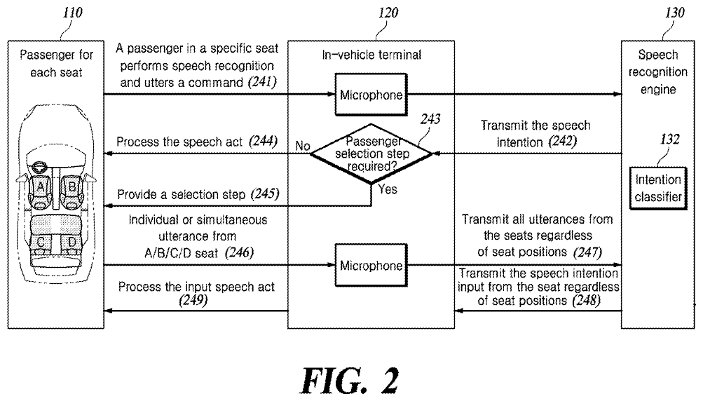

FIG. 2 is a second flow diagram illustrating a speech recognition method.

Passengers 110 for each seat (e.g., all passengers in positions A, B, C, and D of the vehicle) may utter a command after executing speech recognition in the step 241. The command may be, for example, “Open the window” or “Let's go to xx cafe.” The uttered voice may be transmitted to the speech recognition engine 130 through a microphone of the in-vehicle terminal 120.

The speech recognition engine 130 transmits the speech intention to the in-vehicle terminal 120 after speech recognition in the step 242. The speech intention may be, for example, “open the window” or “guide to xx cafe.”

In the step 243, the in-vehicle terminal 120 may determine whether a passenger selection step is required.

If the passenger selection step is not required, the in-vehicle terminal 120 processes a guide message such as “I will open the window” or an operation such as “opening the window” for the passenger 110 of each seat in the step 244.

On the other hand, if the passenger selection step is required, the in-vehicle terminal 120 may provide a selection step to the passenger 110 of each seat in the step 245. The selection step may include, for example, provision of selection items and guidance, for example, “Where should I take you?” For example, the selection items are shown in Table 1 above. Before the selection items are provided in the step 245, it may be possible to list up operable commands.

The passengers 110 for each seat may speak individually or simultaneously in the A/B/C/D seat in the step 246. The uttered voice may be transmitted to the speech recognition engine 130 through the microphone of the in-vehicle terminal 120 in the step 247. At this time, since microphones of all seats are activated, all utterances may be transmitted to the speech recognition engine 130 regardless of seat positions.

The speech recognition engine 130 may transmit the speech intentions received without distinction between seats to the in-vehicle terminal 120 in the step 248. At this time, since natural speech (e.g., chatter) other than the speech for speech recognition is likely to be introduced, the speech recognition engine 130 may fail to classify the speech intentions or may be vulnerable to misclassification.

In the step 249, the in-vehicle terminal 120 may process the speech act of a passenger in the seat where speech recognition is performed. Suppose the passenger may speak individually and correctly generates an utterance; however, a critical problem may arise in terms of passenger's experience with speech recognition if utterances from other seats are introduced at the same time and cause a system failure or malfunction.

In addition, in the procedure of FIG. 2, an uncomfortable situation may arise, requiring everyone except the passenger involved in speech recognition to remain silent during the speech recognition process.

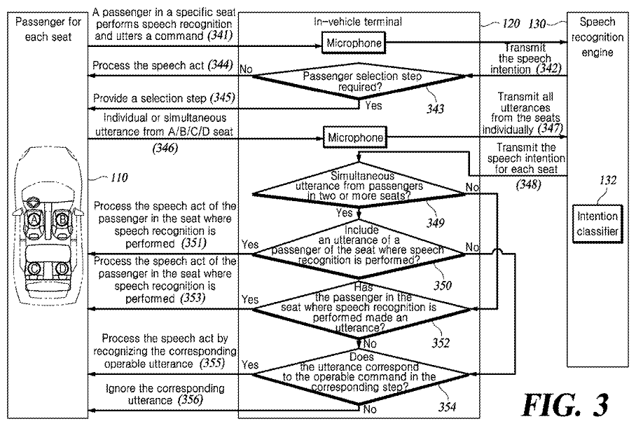

FIG. 3 is a flow diagram illustrating a speech recognition method.

The vehicle head unit system represents the in-vehicle terminal 120, and the speech recognition engine 130 may be configured within the in-vehicle terminal 120 or may be configured separately from the in-vehicle terminal 120.

Passengers 110 for each seat (e.g., a passenger in the specific seat position D among passengers in the positions A, B, C, and D of the vehicle) may utter a command after executing speech recognition in the step 341. The command may be, for example, “Open the window” or “Let's go to xx cafe.” The uttered voice may be transmitted to the speech recognition engine 130 through a microphone of the in-vehicle terminal 120.

The speech recognition engine 130 transmits the speech intention to the in-vehicle terminal 120 after speech recognition in the step 342. The speech intention may be, for example, “open the window” or “guide to xx cafe.”

In the step 343, the in-vehicle terminal 120 may determine whether a passenger selection step is required.

If the passenger selection step is not required, the in-vehicle terminal 120 processes a guide message such as “I will open the window” or an operation such as “opening the window” for the passenger 110 of each seat in the step 344.

On the other hand, if the passenger selection step is required, the in-vehicle terminal 120 may provide a selection step to the passenger 110 of each seat in the step 345. The selection step may include, for example, provision of selection items and guidance, for example, “Where should I take you?” For example, the selection items are shown in Table 1 above. Before the selection items are provided in the step 345, it may be possible to list up operable commands.

The passengers 110 for each seat may speak individually or simultaneously in the A/B/C/D seat in the step 346. The uttered voice may be transmitted to the speech recognition engine 130 through the microphone of the in-vehicle terminal 120 in the step 347. At this time, since microphones of all seats are activated (microphones of all seats are set to the “ON” state), all utterances for each seat may be transmitted individually to the speech recognition engine 130.

In the step 348, the speech recognition engine 130 may determine and classify the speech intention for each seat and then transmit the speech intention to the in-vehicle terminal 120. For example, the speech intention of seat A may include utterances that may not be classified as a specific intention (e.g., chatter), and the speech intention of seat D may correspond to the first item in the list.

In the step 349, the in-vehicle terminal 120 may determine whether passengers of two or more seats have spoken simultaneously.

If the passengers of two or more seats do not speak at the same time, the in-vehicle terminal 120 may proceed to the step 352 to determine whether the passenger in the seat where speech recognition is performed has made an utterance.

If the utterance corresponds to the passenger of the seat where speech recognition is performed, the in-vehicle terminal 120 may process the speech act of the passenger in the seat where speech recognition is performed in the step 353. The in-vehicle terminal 120 may speak, for example, “I will guide you to the first place.”

If the utterance does not correspond to the passenger of the seat where speech recognition is performed, the in-vehicle terminal 120 determines whether the utterance corresponds to an operable command in the step 354. Descriptions of the step 354 will be provided later.

Meanwhile, if passengers of two or more seats make utterances simultaneously, the in-vehicle terminal 120 proceeds to the step 350 to determine whether the utterances include an utterance of a passenger of the seat where speech recognition is performed.

When the utterances include an utterance of a passenger of the seat where speech recognition is performed, the in-vehicle terminal 120 may process the speech act of the passenger of the seat where speech recognition is performed in the step 351. The in-vehicle terminal 120 may speak, for example, “I will guide you to the first place.”

On the other hand, when the utterances do not include an utterance of a passenger of the seat where speech recognition is performed, the in-vehicle terminal 120 may proceed to the step 354 to determine whether the utterances correspond to operable commands in the corresponding step.

If the utterances turn out to include operable commands in the corresponding step, the in-vehicle terminal 120 may recognize the corresponding operable utterance and process the utterance to operate the corresponding command. The in-vehicle terminal 120 may speak, for example, “I will guide you to the first place.”

If the utterances do not include operable commands in the corresponding step, the in-vehicle terminal 120 may ignore the corresponding utterances in the step 356.

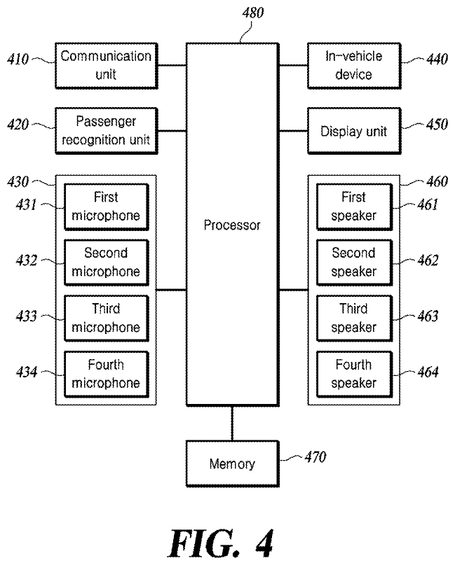

FIG. 4 is a block diagram of a speech recognition apparatus.

The vehicle head unit system represents the in-vehicle terminal 120, and the speech recognition engine 130 may be configured within the in-vehicle terminal 120 or may be configured separately from the in-vehicle terminal 120.

Referring to FIG. 4, the speech recognition apparatus in the vehicle head unit system may comprise a communication unit 410, a passenger recognition unit 420, a speech recognition engine 430, an in-vehicle device 440, a display unit 450, a sound output unit 460, a memory 470, and a processor 480.

The communication unit 410 enables the speech recognition apparatus to communicate with devices located outside the vehicle, namely, external devices (e.g., servers, roadside terminals, and/or other vehicles). Also, the communication unit 410 supports data transmission and reception between the processor 480 and the in-vehicle devices 440. The communication unit 410 may use at least one of communication technologies such as wireless Internet technology, short-range communication technology, mobile communication technology, and vehicle to everything (V2X) technology. Wireless Internet technologies include Wireless LAN (WiFi), Wireless broadband (Wibro), and/or World Interoperability for Microwave Access (Wimax). Short-range communication technologies may include Bluetooth, Near Field Communication (NFC), and/or Radio Frequency Identification (RFID). Mobile communication technologies may include Code Division Multiple Access (CDMA), Global System for Mobile communication (GSM), Long Term Evolution (LTE), and/or International Mobile Telecommunication (IMT)-2020, and 5G (generation). Vehicle communication technologies include Vehicle-to-Vehicle (V2V) communication, Vehicle-to-Infrastructure (V2I) communication, Vehicle-to-Nomadic Devices (V2N) communication, Vehicle-to-Nomadic Devices (V2N) communication, and/or In-Vehicle Network (IVN) communication. IVN may be implemented using Controller Area Network (CAN), Media Oriented Systems Transport (MOST) network, Local Interconnect Network (LIN), Ethernet, and/or X-by-Wire (Flexray).

The passenger recognition unit 420 recognizes passengers in the vehicle, namely, a driver and passengers, through sensors mounted on the vehicle. In other words, the passenger recognition unit 420 may recognize the presence or absence of passengers in the vehicle, passenger locations (e.g., left front seat (driver's seat), right front seat (passenger seat), left rear seat, and right rear seat), and/or passenger ages. The passenger recognition unit 420 may recognize the presence or absence of passengers in the vehicle and the passenger locations using weight sensors mounted on each seat in the vehicle. The passenger recognition unit 420 may estimate the passenger's age by recognizing the passenger's face through an image sensor, that is, a camera, disposed for each seat. At this time, the passenger recognition unit 420 may recognize the passenger's face in conjunction with a driver monitoring system.

The speech recognition engine 430 recognizes a voice query uttered by one (a speech recognition passenger, speaker) of the passengers (e.g., a driver and/or a passenger) in the vehicle. In other words, the speech recognition engine 430 recognizes a voice command when one of the speech recognition passengers utters the corresponding voice command. The speech recognition engine 430 collects acoustic signals generated within the vehicle through a plurality of microphones 431 to 434 installed for each seat within the vehicle. The speech recognition engine 430 extracts the passenger's voice included in the acoustic signal. In other words, the speech recognition engine 430 receives a voice signal uttered by each passenger through a first microphone 431, a second microphone 432, a third microphone 433, and a fourth microphone 434 installed respectively in the front left (FL) seat (driver's seat, front right (FR), rear left (RL), and rear right (RR) seat. Here, the microphone is a sound sensor that receives external acoustic signals and converts them into electrical signals. A variety of noise removal algorithms may be applied to the microphone to remove noise received along with the acoustic signal. In other words, the microphone may remove noise, generated during driving or introduced from the surroundings, from a sound signal received from the outside and output a noise-removed sound. In some implementations, four microphones are installed; however, the present disclosure is not limited to the specific case, and the number of installed microphones may change depending on the number of seats in the vehicle.

The speech recognition engine 430 converts a voice signal input through at least one of the first 431 to fourth microphones 434 into text (character data) using a speech-to-text (STT) technique. The speech recognition engine 430 analyzes the meaning (speech intention) of the converted text using Natural Language Understanding (NLU) techniques and outputs speech recognition results.

The speech recognition results (speech intentions) may include control commands corresponding to voice queries (voice commands).

The speech recognition engine 430 may detect the speaker's location, namely, the location where a voice signal is coming from (voice input position). The speech recognition engine 430 recognizes the installation location of a microphone with a voice input as the voice input position. At this time, the speech recognition engine 430 determines the voice input position by referring to a lookup table that defines the installation position of each microphone pre-stored in the memory. The speech recognition engine 430 may perform speech recognition by selectively using various well-known speech-to-text transformation techniques and natural language understanding techniques. The speech recognition engine 430 may include a memory capable of storing a speech recognition algorithm and a voice database and a processor that executes the speech recognition algorithm.

The speech recognition engine 130 may include an intention classifier 132, and the intention classifier 132 may determine a speech intention for each seat and classify the speech intention.

The in-vehicle device 440 is a device installed inside the vehicle and includes at least one of the convenience devices such as an Audio Video Navigation (AVN) device, a multimedia device, an air conditioning device, a window opening and closing device, and a data transmission/reception device. The in-vehicle device 440 performs predetermined operations according to instructions from the processor 480. For example, the in-vehicle device 440 may turn on the air conditioner, operate the seat heater of the driver's seat, or close the window according to the control of the processor 480.

The display unit 450 outputs the progress status and/or results according to the operation of the processor 480 in the form of visual information. The display unit 450 may be implemented using at least one of a liquid crystal display (LCD), a thin film transistor-liquid crystal display (TFT LCD), an organic light-emitting diode (OLED) display, a flexible display, a 3D display, a transparent display, a head-up display (HUD), and a touch screen and a cluster.

The sound output unit 460 outputs auditory information according to instructions from the processor 480 and may include a plurality of speakers 461 to 464 installed for each seat in the vehicle. In other words, the sound output unit 460 may output an audio signal (including a voice signal) through at least one of the first speaker 461, second speaker 462, third speaker 463, and fourth speaker 464 installed in the left front seat, right front seat, left rear seat, and right rear seat, respectively.

The memory 470 may store software for the processor 480 to perform a predetermined operation. The memory 470 may temporarily store input data and/or output data of the processor 480. The memory 470 may be implemented using at least one of storage media (recording media), including flash memory, hard disk, Secure Digital Card (SD card), Random Access Memory (RAM), Static Random Access Memory (SRAM), Read Only Memory (ROM), Programmable Read Only Memory (PROM), Electrically Erasable and Programmable ROM (EEPROM), Erasable and Programmable ROM (EPROM), registers, removable disks, and web storage.

The processor 480 controls the overall operation of the speech recognition apparatus in the vehicle head unit system. The processor 480 may be implemented using at least one of application specific integrated circuits (ASICs), digital signal processors (DSPs), programmable logic devices (PLDs), field programmable gate arrays (FPGAs), central processing units (CPUs), microcontrollers, and microcontrollers.

When the vehicle's engine is turned on, the processor 480 may detect the presence or absence of passengers in the vehicle, passenger locations, and/or passenger ages through the passenger recognition unit 420. At this time, the processor 480 recognizes a passenger who may use the speech recognition function (i.e., a speech recognition passenger) based on the presence or absence of passengers, passenger locations, and/or passenger ages. In other words, the processor 480 distinguishes and recognizes a speech recognition passenger among the passengers in the vehicle.

The processor 480 may be configured to perform the operation of the in-vehicle terminal 120 described in FIG. 3. In some implementations, the processor 480 may be configured to prioritize and process the utterance of the first speech recognition passenger.

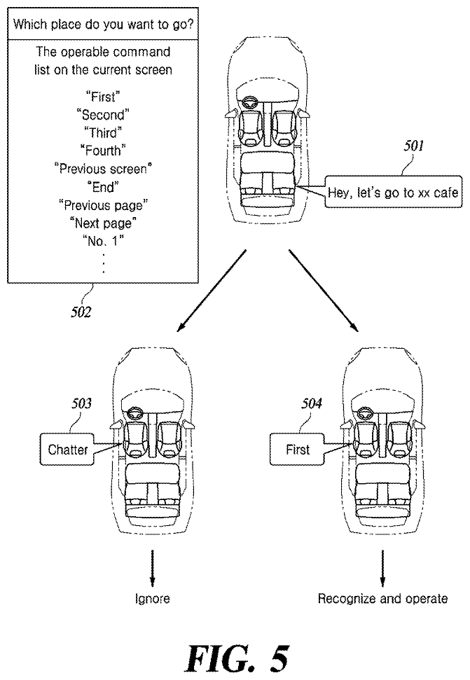

FIG. 5 is a first example illustrating a speech recognition method used in the right rear seat in a vehicle.

In the step 501, when a passenger in the right rear seat performs speech recognition and says, “Hey, let's go to xx cafe,” the processor 490 displays a list of operable commands (referred to as the “best list” hereinafter) on the screen of the in-vehicle terminal in the step 502, accompanied by a guiding sound such as “Which place do you want to go?”

The subsequent scenarios, Case 1 and Case 2, are described as follows.

Case 1) In the step 503, when the passenger in the driver's seat is having a chat, the processor 490 may ignore the utterances (e.g., chatter) which are the operable utterances in the best list. In other words, when a passenger in the right rear seat performs speech recognition and says “Hey, let's go to xx cafe,” the processor 490 may ignore an utterance of the passenger in the driver's seat if the utterance is not an operable utterance in the best list.

Case 2) In the step 504, when the passenger in the driver's seat utters “first” included in the best list, the processor 490 may recognize and process the utterance. In other words, when a passenger in the right rear seat performs speech recognition and says “Hey, let's go to xx cafe,” and then the passenger in the driver's seat says “first” from the best list, the processor 490 may process the first operation from the best list.

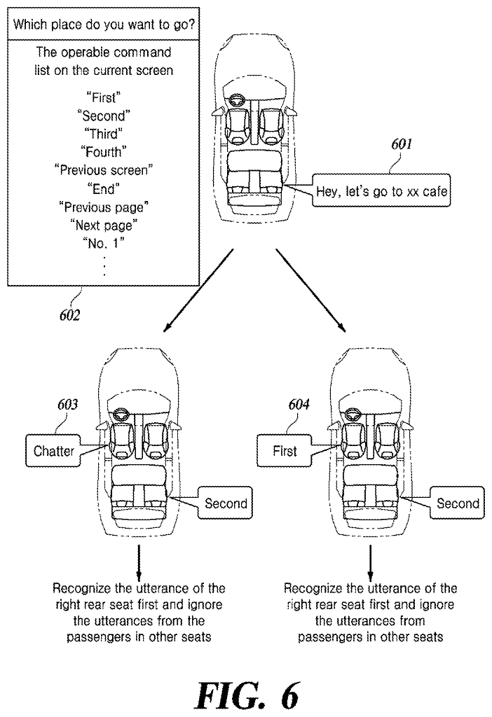

FIG. 6 is a second example illustrating a speech recognition method used in the right rear seat in a vehicle.

If a passenger in the right rear seat performs speech recognition and says “Hey, let's go to xx cafe” in the step 601, the processor 490 displays the best list on the screen of the in-vehicle terminal and guides sound such as “Which place do you want to go?” is output.

The subsequent scenario, Case 3, is described as follows.

Case 3) In the step 603, if the passenger in the driver's seat is having a chat, and the passenger in the right rear seat utters “second” from the best list (simultaneous utterance), the processor 490 may recognize the utterance of the passenger in the right rear seat first and ignore the utterances from the passengers in other seats.

In the step 604, if the passenger in the driver's seat utters “first” from the best list, and the passenger in the right rear seat utters “second” from the best list (simultaneous utterance), the processor 490 may recognize the utterance of the passenger in the right rear seat first and ignore the utterances from the passengers in other seats. In other words, the processor 490 gives priority to recognizing the utterance the first speaker.

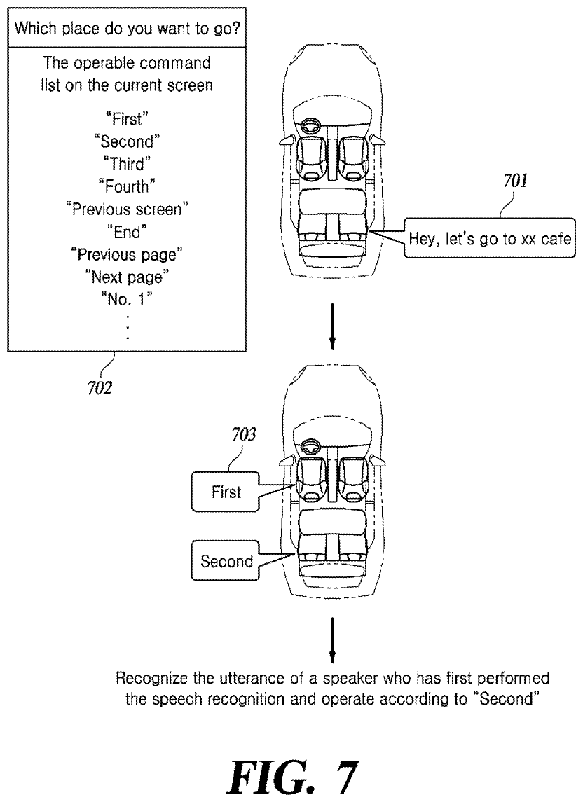

FIG. 7 is a third example illustrating a speech recognition method used in the right rear seat in a vehicle.

If the passenger in the right rear seat performs speech recognition and says “Hey, let's go to xx cafe” in the step 701, the processor 490 displays the best list on the screen of the in-vehicle terminal and guides sound such as “Which place do you want to go?” is output in the step 702.

The subsequent scenario, Case 4, is described as follows.

Case 4) In the step 703, if the passenger in the driver's seat utters “first” from the best list, and the passenger in the right rear seat moves to the left rear seat and utters “second” (the step 703 is a simultaneous utterance step), the processor 490 may recognize the utterance of a speaker who has performed the first speech recognition through a speaker recognition function and thus may process the “second” even if the corresponding passenger moves to another seat. At this time, the processor 490 may recognize the utterance of a speaker who has first performed the speech recognition using a speaker recognition logic.

In the drawings above, processes are described as being sequentially executed, which is merely an illustrative explanation of the technical principles of one implementation of the present disclosure. In other words, since a person skilled in the art to which one implementation of the present disclosure belongs may generate various modifications and variations of the present disclosure by changing the execution order described in the drawings or performing one or more of the processes in parallel without departing from the essential characteristics of one implementation of the present disclosure, the drawings are not limited to a sequential order of execution.

Meanwhile, the processes described with reference to FIGS. 3 to 7 may be implemented in the form of computer-readable program codes in a computer-readable recording medium. The computer-readable recording medium includes all kinds of recording devices storing data that may be read by a computer system. In other words, examples of computer-readable recording media include non-transitory recording media, such as a ROM, a RAM, a CD-ROM, a magnetic tape, a floppy disk, and an optical data storage device. Also, the computer-readable recording medium may be distributed over computer systems connected to each other through a network so that computer-readable codes may be stored and executed in a distributed manner.

In the drawings described above, the processes are described as being sequentially executed, but merely illustrate the technical spirit of some implementations of the present disclosure. In other words, a person having ordinary skill in the art to which some implementations of the present disclosure pertain may variously modify and apply the present disclosure by changing and executing the processes described in the flowchart or executing one or more of the processes in parallel without departing from an intrinsic characteristic of some implementations of the present disclosure, and thus the drawings are not limited to a time-series sequence.

Meanwhile, the processes shown in FIGS. 3 to 4 and FIGS. 5 to 7 may be implemented as computer-readable codes on a computer-readable recording medium. The computer-readable recording medium may include all types of recording devices that store data that may be read by a computer system. That is, such computer-readable recording medium includes non-transitory mediums, such as ROM, RAM, CD-ROM, magnetic tape, floppy disk, and optical data storage devices. In addition, computer-readable recording mediums may be distributed to a computer system connected by a network and computer-readable code may be stored and executed in a distributed manner.

In addition, the components of the present disclosure may use integrated circuit structures, such as memory, processor, logic circuit, look-up table, etc. These integrated circuit structures execute each function described herein through control of one or more microprocessors or other control devices. In addition, the components of the present disclosure may be specifically implemented by a program or portion of code that includes one or more executable instructions for performing specific logical functions and is executed by one or more microprocessors or other control devices. In addition, the components of the present disclosure may include or be implemented by a central processing unit (CPU), a microprocessor, etc. that perform respective functions thereof. In addition, the components of the present disclosure may store instructions executed by one or more processors in one or more memories.

What is claimed is:

1. A method for speech recognition in a vehicle, the method comprising:
processing an utterance of a first passenger, the utterance requesting execution of speech recognition;
generating a command list based on the utterance;
determining, based on a plurality of utterances being simultaneously received from a plurality of seats, respectively, intention of each of the plurality of utterances; and
processing a speech act of a first utterance among the plurality of utterances based on the intention of each utterance.

2. The method of claim 1, wherein processing the speech act of the first utterance includes:
based on (i) the utterance of the first passenger being requested the execution of speech recognition and (ii) the plurality of utterances being simultaneously received in response to the command list, prioritizing the processing of a speech act of the utterance from the first passenger.

3. The method of claim 1, wherein processing the speech act of the first utterance includes:
based on (i) the utterance of the first passenger being requested the execution of speech recognition and (ii) the plurality of utterances being simultaneously received in response to the command list, recognizing only the utterance from the first passenger to be processed among the plurality of utterances.

4. The method of claim 1, wherein processing the speech act of the first utterance includes:
based on (i) the utterance of the first passenger being requested the execution of speech recognition, (ii) the first passenger being moved to another seat in the plurality of seats, and (iii) the plurality of utterances being simultaneously received in response to the command list, recognizing the utterance from the first passenger to be processed, and
wherein the first passenger initially executed the speech recognition through a speech recognition logic.

5. The method of claim 1, wherein processing the speech act of the first utterance includes:
based on (i) the utterance of the first passenger being requested the execution of speech recognition and (ii) the intention of utterance from a second passenger, in response to the command list, being found within the command list, processing a speech act of the utterance from the second passenger.

6. The method of claim 5, further comprising:
ignoring, based on the first passenger being requested the execution of speech recognition and the intention of the utterance from the second passenger, in response to the command list, not being found within the command list, the utterance from the second passenger.

7. The method of claim 1, further comprising:
based on the utterance of the first passenger being received, determining the intention of the utterance of the first passenger and classifying a content of the utterance for each passenger.

8. The method of claim 1, further comprising:
based on the utterance of the first passenger being received, identifying a position of the utterance of the first passenger.

9. The method of claim 1, wherein processing the speech act of the first utterance includes:
based on the intention of the utterance from each seat being found within the command list, determining a voice of a passenger in a corresponding seat as a valid command.

10. The method of claim 1, wherein a microphone for each seat is activated.

11. An apparatus configured to recognize speech in a vehicle, the apparatus comprising:
a memory storing instructions; and
a processor configured to execute the instructions to perform operations comprising:
processing an utterance of a first passenger, the utterance requesting execution of speech recognition,
generating a commands list based on the utterance,
determining, based on a plurality of utterances being simultaneously received from a plurality of seats, respectively, intention of each of the plurality of utterances; and
processing a speech act of a first utterance among the plurality of utterances based on the intention of from each utterance.

12. The apparatus of claim 11, wherein the processor is configured to, based on (i) the utterance of the first passenger being requested the execution of speech recognition and (ii) the plurality of utterances being simultaneously received in response to the command list, prioritize the processing of a speech act of the utterance from the first passenger.

13. The apparatus of claim 11, wherein the processor is configured to, based on (i) the utterance of the first passenger being requested the execution of speech recognition and (ii) the plurality of utterances being simultaneously received in response to the command list, recognize only the utterance of the first passenger to be processed among the plurality of utterances.

14. The apparatus of claim 11, wherein the processor is configured to, based on (i) the utterance of the first passenger being requested the execution of speech recognition, (ii) the first passenger being moved to another seat in the plurality of seats, and (iii) the plurality of utterances being simultaneously received in response to the command list, recognize the utterance of the first passenger to be processed, and
wherein the first passenger initially executed the speech recognition through a speech recognition logic.

15. The apparatus of claim 11, wherein the processor is configured to, based on (i) the utterance of the first passenger being requested the execution of speech recognition and (ii) the intention of utterance from a second passenger, in response to the command list, being found within the command list, process a speech act of the utterance from the second passenger.

16. The apparatus of claim 15, wherein the processor is configured to, based on the utterance of the first passenger being requested the execution of speech recognition and the intention of the utterance from the second passenger, in response to the command list, not being found within the command list, ignore the utterance from the second passenger.

17. The apparatus of claim 11, wherein the processor is configured to, based on the utterance of the first passenger being received, determine the intention of the utterance and classify a content of the utterance for each passenger.

18. The apparatus of claim 11, wherein the processor is configured to, based on the utterance of the first passenger being received, identify a position of the utterance of the first passenger.

19. The apparatus of claim 11, wherein the processor is configured to, based on the intention of the utterance from each seat being found within the command list, determine a voice of a passenger in the corresponding seat as a valid command.

20. The apparatus of claim 11, wherein a microphone for each seat is activated.
